(19) United States
(12) Patent Application Publication
(10) Pub. No.: US 2024/0428525 A1
(43) Pub. Date: Dec. 26, 2024

(54) SYSTEMS AND METHODS FOR GENERATING VIRTUAL ENVIRONMENTS INCLUDING VEHICLES

(71) Applicant: Toyota Motor North America, Inc., Plano, TX (US)

(72) Inventors: Nick Anthony Megariotis, Irvine, CA (US); Roger Akira Kyle, Aubrey, TX (US); Timothy Wang, Ann Arbor, MI (US); Justin K. Shen, Canton, MI (US); Imad Zahid, Carrollton, TX (US)

(73) Assignees: Toyota Motor North America, Inc., Plano, TX (US); Toyota Jidosha Kabushiki Kaisha, Aichi-ken (JP)

(21) Appl. No.: 18/339,750

(22) Filed: Jun. 22, 2023

(51) Int. Cl. G06T 19/00; G06F 1/16; G06T 15/20; H04N 7/18

(52) U.S. Cl. CPC G06T 19/006; G06F 1/163; G06T 15/20; H04N 7/183

(57) ABSTRACT

Systems and methods for generating virtual environments including virtual vehicles are disclosed. In one embodiment, a method of presenting a virtual environment includes receiving vehicle sensor data from one or more vehicles in a physical environment rendering the virtual environment that represents the physical environment, rendering one or more virtual vehicle representations of the one or more vehicles using the vehicle sensor data such that movement of the one or more virtual vehicle representations within the virtual environment corresponds with movement of the one or more vehicles in the physical environment, and transmitting data for displaying the virtual environment and the one or more virtual vehicle representations to a plurality of display devices.

### TECHNICAL FIELD

The present specification relates to virtual environments.

### BACKGROUND

Major events, such as vehicle races, are popular to attend. However, it may be difficult for people attend for a variety of reasons. Additionally, it may be difficult for people to experience remote off-road trails. Accordingly, alternative means for experiencing such places and events are desired.

### SUMMARY

In one embodiment, a method of presenting a virtual environment includes receiving vehicle sensor data from one or more vehicles in a physical environment, rendering the virtual environment that represents the physical environment, rendering one or more virtual vehicle representations of the one or more vehicles using the vehicle sensor data such that movement of the one or more virtual vehicle representations within the virtual environment corresponds with movement of the one or more vehicles in the physical environment, and transmitting data for displaying the virtual environment and the one or more virtual vehicle representations to a plurality of display devices.

In another embodiment, a system for presenting a virtual environment includes one or more processors, a transceiver for transmitting and receiving data, a non-transitory computer-readable medium storing instructions that, when executed by the one or more processors, causes the one or more processors to receive, using the transceiver, vehicle sensor data from one or more vehicles in a physical environment, render the virtual environment that represents the physical environment, render one or more virtual vehicle representations of the one or more vehicles using the vehicle sensor data such that movement of the one or more virtual vehicle representations within the virtual environment corresponds with movement of the one or more vehicles in the physical environment, and transmit, using the transceiver, data for displaying the virtual environment and the one or more virtual vehicle representations to a plurality of display devices.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 illustrates an example user wearing a virtual reality headset according to one or more embodiments described and illustrated herein.

FIG. 2 illustrates a virtual racetrack according to one or more embodiments described and illustrated herein.

FIG. 3 illustrates an example vehicle according to one or more embodiments described and illustrated herein.

FIG. 4 illustrates an example driver stat card according to one or more embodiments described and illustrated herein.

FIG. 5 illustrates an example virtual off-road trail according to one or more embodiments described and illustrated herein.

FIG. 6 illustrates a virtual booth according to one or more embodiments described and illustrated herein.

FIG. 7 illustrates an example system for rendering a virtual environment including virtual vehicles according to one or more embodiments described and illustrated herein.

FIG. 8 illustrates an example computing device for rendering a virtual environment including virtual vehicles according to one or more embodiments described and illustrated herein.

### DETAILED DESCRIPTION

The embodiments disclosed herein are directed to systems and methods for rendering and displaying virtual environments for users to meet, gather, and experience events. Particularly, the virtual environments are tailored for users who are vehicle enthusiasts or are otherwise interested in vehicles. Generally, the systems and methods described herein take real-world data from real-world environments and objects, such as vehicles, and create a virtual environment for users to experience. The virtual environment may be a location within the metaverse, for example, where users can create avatars to interact and experience virtual and/or real-world events.

In many situations, people cannot physically travel to attend an event (e.g., a sporting event, a trade-show, a meet-and-greet, etc.) or meet in person to discuss topics, such as hobbies or shared interests. This may be due to costs constraints, weather, physical disabilities, or other barriers to physically attending the event in person.

Embodiments of the present disclosure provide virtual parks within a virtual environment (i.e., the metaverse) where users can gather to participate in special events or to discuss topics of interest. As used herein a “virtual park” or “park” means a location in the virtual environment particular to a certain topic or event. For example, a park may be dedicated to a certain vehicle, such as a Toyota 4Runner, where users can visit using their avatars to discuss topics relating to the Toyota 4Runner, view and virtually try out new prototype parts, discuss and view the latest modifications, peruse third party accessory manufacturers in a convention floor-space/booth environment, and virtually test drive Toyota 4Runners.

As another example, the virtual parks may host real-world events within the virtual environment. For example, a real-world car race may be live-streamed within the virtual environment at a virtual park. Users may view the live-streamed car race from different perspectives.

As used herein, the term “racecar” means a vehicle that travels greater than 150 kph in a racing environment. As used herein, the term “racetrack” means a location for which its primary purpose is for racing vehicles. As used herein, an “off-road vehicle” is a four-wheel drive vehicle. As used herein, the term “off-road trail” means an unpaved road.

Various embodiments of systems and methods of presenting virtual environments are described in detail below.

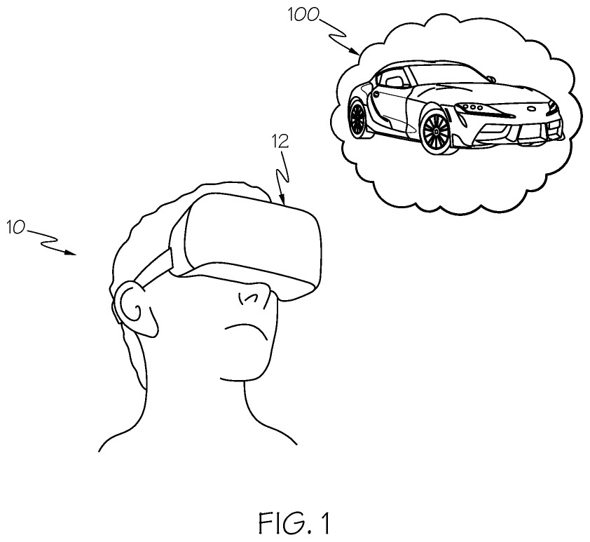

Referring now to FIG. 1, a user 10 wearing a display device comprising a virtual reality headset 12 is illustrated. The user 10 is experiencing a virtual environment 100 as displayed by the headset 12. As described in detail below, the virtual environment may include various parks of different subject matters for the user 10 to visit and experience. Embodiments are not limited to being experienced by virtual reality headsets. The display device may be augmented reality glasses, smart phones, tablets, laptop computers, projectors, or other types of display devices.

The virtual parks described herein may be any type of virtual gathering place for users to attend and visit the other avatars meet, experience, and enjoy. As stated above, a virtual park may be a virtual location that is tailored to users having common interests. For example, a virtual park dedicated to the Toyota 4Runner is a place where users can virtually meet to discuss and experience all the latest relating to Toyota 4Runner trucks. As another example, a virtual park may be dedicated to racecar driving where users can discuss different racecars, technologies, tracks and the like. At this virtual park, users may also virtually race vehicles at different racetracks.

In some embodiments, access to the different virtual parks may be limited to those meeting certain criteria. In one example, users may earn a non-fungible token when they purchase an object, such as a vehicle like a Toyota 4Runner. Users may then use their nonfungible token to gain access to the Toyota 4Runner virtual park. As another example, users may unlock access to a virtual park or different areas of the virtual park by earning tokens when performing certain tasks for completing objectives. In this manner, the purchase of vehicles or other objects may be gamified to encourage such purchases to gain access to virtual experiences at different virtual parks. Such embodiments bring real-world actions into the virtual world. As a nonlimiting example, users who purchase a certain number of accessories for their truck can gain access to different areas of the virtual park, such as different virtual off-road trails, exclusive events or different chat rooms.

These virtual parks may also enable users to virtually test drive vehicles in a virtual environment. A user may test drive a single vehicle model across different terrains, tracks, off-road environments, streets, and the like. Or a user may test drive multiple across different terrains, tracks, off-road environments streets and the like. Virtual car sales personnel may be present to answer questions for users test driving virtual vehicles. Further, other enthusiasts may also provide recommendations and answer questions to those who are test driving the vehicles.

The virtual park may also be configured to allow users to select different colors, trim packages and options of vehicles to test. The users can then test drive these virtual vehicles that they have designed in different environments such as city streets, highways, and off-road environments. Thus, users may personalize vehicles for either enjoying in the virtual world, or perhaps purchasing in the physical world.

Vehicle manufacturers may also use the virtual parks to collect customer feedback to gather sentiment data regarding products and customer experiences. Data from activities within the virtual parks can be used to develop new products for purchase in the real world.

These virtual parks may also have a marketplace where third-party vendors may set up virtual booths to sell products, services and experiences to users. In some embodiments, the operator of the virtual park can sell virtual booth space to vendors. Users may attend peruse the marketplace, looking at the different virtual booths as if they were at a physical market or convention floor.

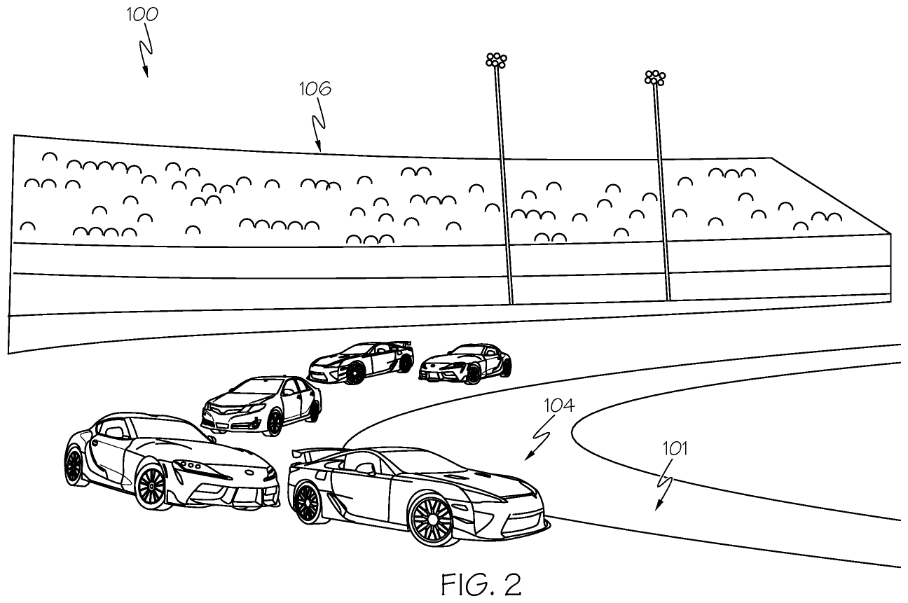

As one nonlimiting example, a virtual park may feature a racetrack including stands, meeting spaces, and vendor booths surrounding the racetrack. Here, users may gather to watch races at the racetrack, meet and discuss various topics at the meeting space, and shop and visit at the vendor booths. Referring now to FIG. 2, a virtual environment 100 configured as a racetrack environment is illustrated. Users may experience the racetrack of the virtual environment from different perspectives as described in detail below. In this example, the virtual environment comprises a racetrack 101, stands 106, and virtual racecar vehicles 104. The racecar vehicles 104 and the racetrack 101 may be purely virtual, mixed virtual and actual reality, or streamed video data of actual reality. For example, in a purely virtual environment, all of the objects are computer-generated. In a mixed virtual and actual reality environment, some of the objects are computer-generated, while other objects are physical objects within a video datastream of the physical objects and actual environment. For example, in a racecar example, a physical race that is occurring is filmed by cameras at the racetrack to produce a video datastream that is provided and played within the virtual environment. Computer-generated objects, such as other racecars that are not physically present in the actual environment may be displayed and viewable to users in the virtual environment 100. In an actual reality environment, the video that is presented to the user is video of the actual environment without computer-generated objects. For example, in a live stream of a racing virtual environment 100, the video datastream of the race is viewable to the users without augmentation by computer-generated objects.

The events that occur at a physical racetrack during the actual race may be reproduced in the virtual environment 100. Environmental sensors at the racetrack are provided to produce environmental data that provides information regarding the physical environment. Any type of environmental sensor may be utilized. Example environmental sensors include temperature sensors, humidity sensors, barometer sensors, air quality sensors, cameras, infrared sensors, and the like. The environmental data, environmental sensors is used to reproduce a virtual environment 100 that reflects the actual environment. For example, when it is a sunny day, the environmental data will reflect this such that a sunny day is reproduced in the virtual environment 100. Similarly, if it is raining actual environment, it may also be in the virtual environment 100.

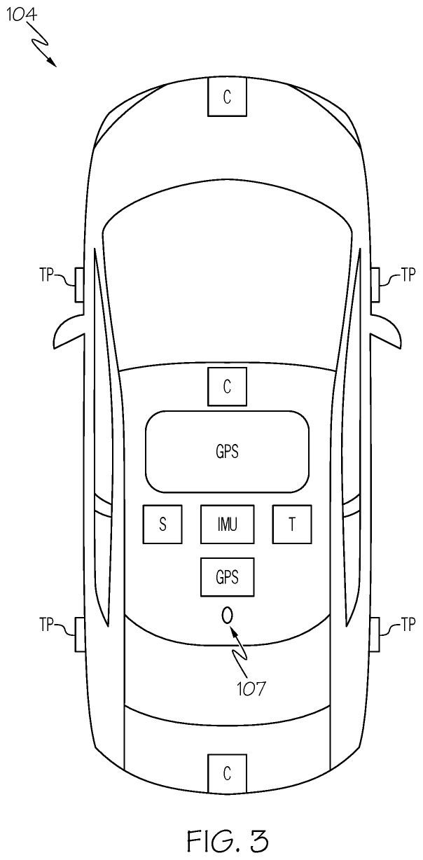

In embodiments, each of the racecars at the racetrack may be equipped with a plurality of sensors that provide data regarding position and movement on the racetrack. Referring now to FIG. 3, a vehicle 104 having a plurality of sensors is illustrated. Embodiments are not limited by the type and number of sensors that are utilized. Example sensors include tire pressure sensors TP, global positioning sensor (GPS), speedometer S, temperature sensor T, inertial measurement unit sensors (IMU), and one or more video cameras C. These vehicle sensors produce vehicle data that is used to render virtual vehicles 104 and the virtual environment 100. For example, vehicle speed data, GPS data, and IMU data are used to replicate the movement of the physical vehicle in the virtual environment 100. Thus, the virtual vehicles 104 move in the same manner on the virtual racetrack as the actual vehicles move on the physical environment. In this manner, visitors to the virtual environment 100 can experience the physical race at the racetrack without being physically present. A real-world race can be live streamed to the park in either all virtual reality, mixed reality, and/or live video datastream.

The vehicle 104 further includes communication hardware, such as a transceiver, that is operable to send its vehicle data to a cloud computing system or to a local computing device that further transmits the vehicle data to a cloud computing system.

The racecars can have cameras mounted on the roof, on the sides, the front, at the rear, and in the cabin to provide many video datastream sources that can be selected by a user at the park. A user may select the video datastream from the cockpit of her favorite driver such that she may view the actual race from the driver's perspective.

In some embodiments, credentials may be earned to access different camera views or perspectives. Users may earn nonfungible tokens based on real-world activity or virtual world activity that provide access to different areas of the virtual racetrack. For example, users can earn better seats, different viewing points, or access to the cameras of her favorite driver.

The system may even enable a user at the virtual park to drive a virtual vehicle on the virtual racetrack that represents the actual race being produced by the environmental data in the vehicle data. In this manner, a user may race famous racecar drivers while the race is going on. The user may select to only a race against the real-world drivers, or to also race against real-world drivers plus other virtual drivers. This makes for a unique and fun experience for those attending the virtual park.

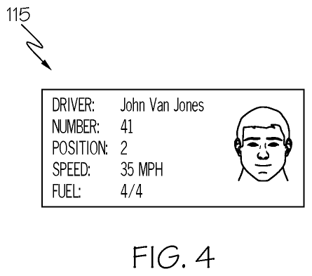

The vehicle data could also be used to generate additional objects or features that can be selected for viewing by the user. Referring now to FIG. 4, an example driver's stat card is illustrated. This stat card can be generated and displayed proximate to a selected driver. The stat card uses vehicle data from the vehicle sensors to generate and display information associated with a particular driver. Information such as speed, fuel level, driver number, driver name and current position can be included in the stat card. A user can select a driver for which to display a stat card. The stat card can be toggled on and off. In this way, the virtual park attendee can customize information to be displayed about various drivers.

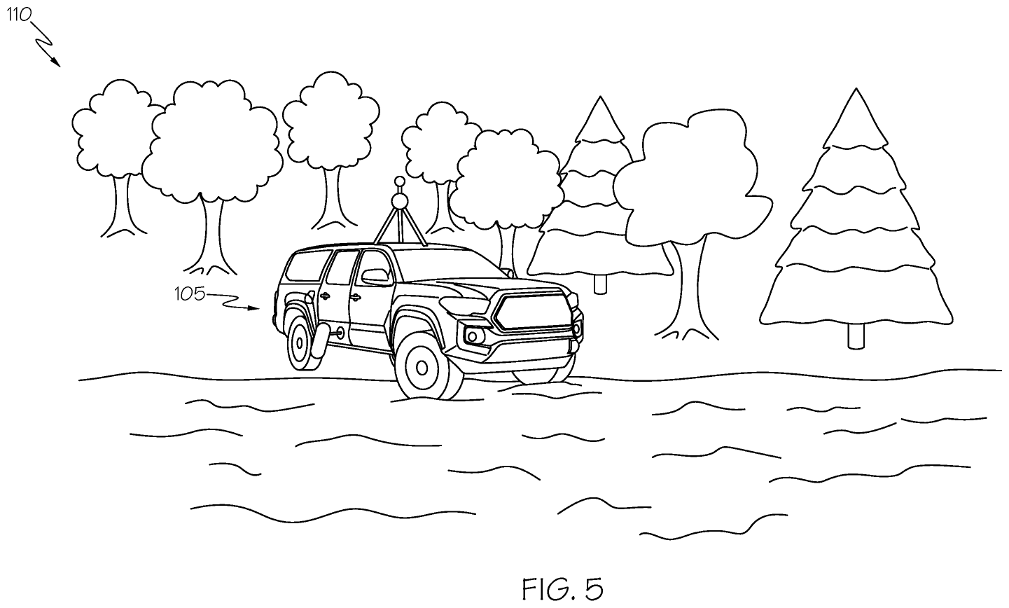

Virtual parks are not limited to racetracks. Referring now to FIG. 5, a virtual park configured as an off road trail 110 is illustrated. The virtual vehicle 105 that is an off road vehicle is shown traversing the off road trail 110. The off-road trail may be a real off-road trail that is virtually reproduced in the virtual environment. Users may practice on the virtual off-road trail before making a trip to drive his or her vehicle on the real off-road trail.

Alternatively, the off-road trail may be completely virtual and not tied to any physical trail. Users may drive off road vehicles on the trail to practice and test their skills. As an example, the user can select different weather conditions such as snowy or sunny, or other environmental conditions.

In some embodiments, the virtual vehicle possesses attributes of a user's actual physical vehicle. For example, a user may own a Toyota 4Runner of a certain year and trim level, as well as different accessories. The user may build the virtual representation of his or her actual by selecting different options. In some embodiments, vehicle sensor data from the user's actual vehicle is used, to create a vehicle profile such that the virtual vehicle behaves in a similar manner as the physical vehicle. Therefore, performance of the actual vehicle is reflected by the virtual vehicle.

In other cases, the virtual vehicle is not tied to any real world vehicle. Users may select different vehicles and accessories to try them out on a virtual trail before making a purchase, for example.

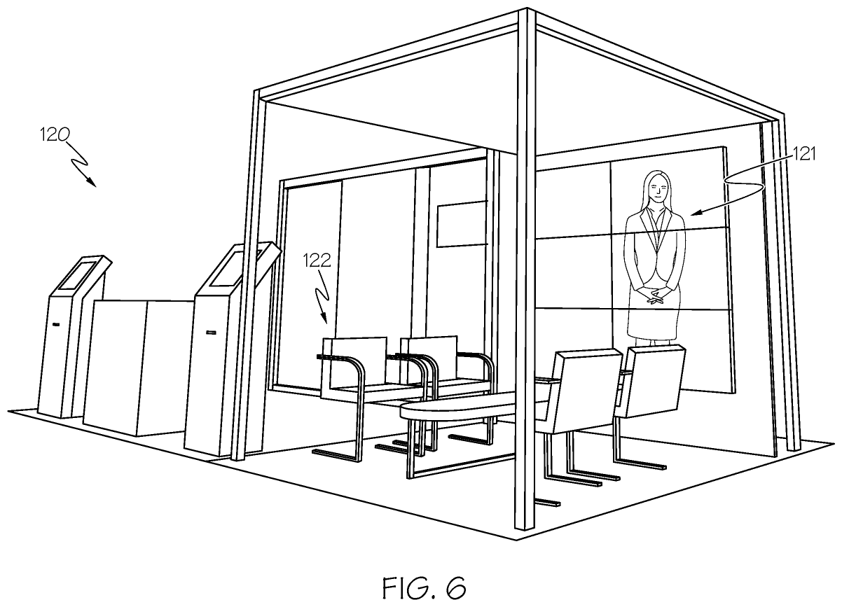

Referring now to FIG. 6, a virtual booth 120 is illustrated. The virtual booth 120 provides a space for a vendor to provide information about its products as well as to meet potential customers in the form of their meta-verse avatars. The space may have seating 122 to sit down on, or watch video presentations on one or more displays 121. Such virtual booths 120 may be arranged in a virtual convention center hall where users can walk by and interact with the virtual booth. The virtual booths 120 may be manned by avatars operated by actual people or by artificial intelligence generated customer service representatives.

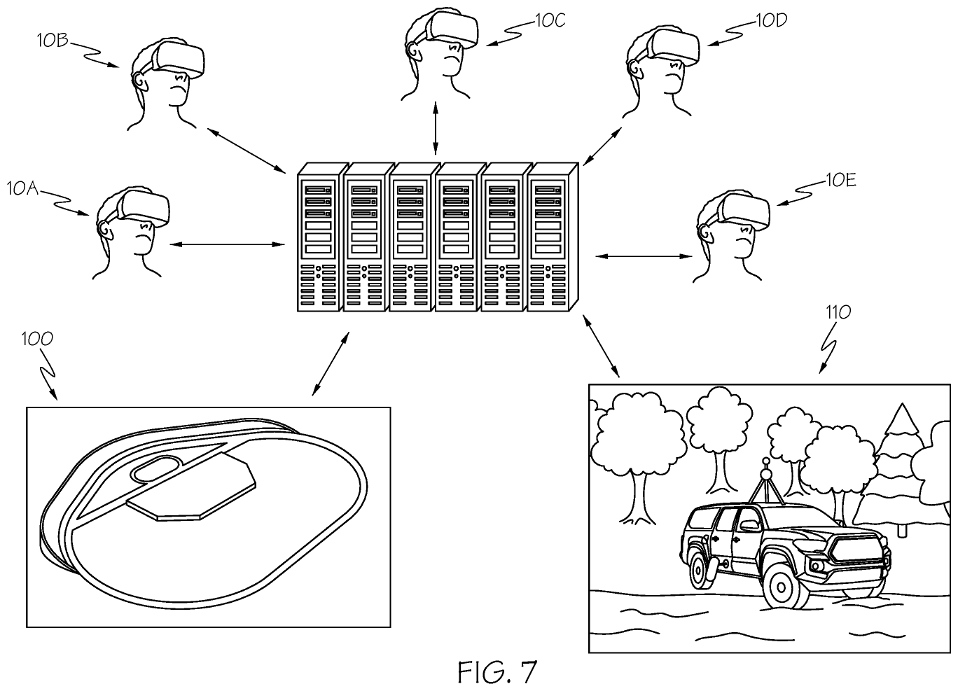

FIG. 7 illustrates a system 200 for providing virtual environments to a plurality of users 10A-10E. Environmental data and vehicle data from various real life locations, such as a racetrack 101 and an off road trail 110, is provided to a cloud system 210. The cloud system 210 receives this data and uses it to render various virtual environments such as the virtual parks described herein. Data representing the virtual parks is then provided to the display devices of the plurality of users 10A-10E. The display devices then render the virtual parks or other virtual environments. Control inputs from one or more input devices of the users 10A-10E is communicated back to the cloud system 210, such that the virtual parts that are rendered reflect the input commands of the users 10A-10E.

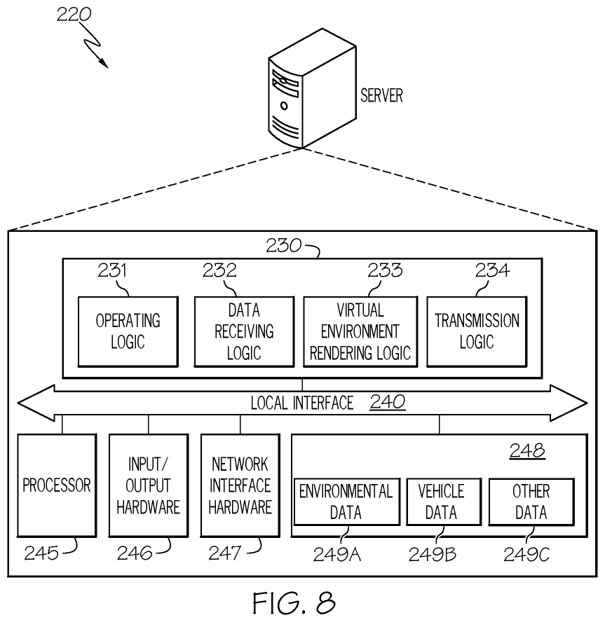

Embodiments of the present disclosure may be implemented by a computing device, and may be embodied as computer-readable instructions stored on a non-transitory memory device. Referring now to FIG. 8, an example system for providing a virtual environment as a computing device 220 is schematically illustrated. The computing device 220 may be a component of the cloud system 210 shown in FIG. 7, for example. The example computing device 220 provides a system for generating a virtual environment, and/or a non-transitory computer usable medium having computer readable program code for generating a virtual environment embodied as hardware, software, and/or firmware, according to embodiments shown and described herein. While in some embodiments, the computing device 220 may be configured as a general purpose computer with the requisite hardware, software, and/or firmware, in some embodiments, the computing device 220 may be configured as a special purpose computer designed specifically for performing the functionality described herein. It should be understood that the software, hardware, and/or firmware components depicted in FIG. 8 may also be provided in other computing devices external to the computing device 220 (e.g., data storage devices, remote server computing devices, and the like).

As also illustrated in FIG. 8, the computing device 220 (or other additional computing devices) may include a processor 245, input/output hardware 246, network interface hardware 247, a data storage component 248 (which may include recorded environmental data 249A (e.g., data regarding the physical environment of an event or location), vehicle data 249B (e.g., data relating to vehicles within the physical environment), and any other data 249C for performing the functionalities described herein), and a non-transitory memory component 230. The memory component 240 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 230 may be configured to store operating logic 231, data receiving logic 232 for receiving environmental and vehicle data, virtual environment rendering logic 233 for rendering virtual environments (including virtual vehicles), and transmission logic 234 for communicating data to and from display devices of a plurality of users, as described herein (each of which may be embodied as computer readable program code, firmware, or hardware, as an example). It should be understood that the data storage component 248 may reside local to and/or remote from the computing device 220, and may be configured to store one or more pieces of data for access by the computing device 220 and/or other components.

A local interface 240 is also included in FIG. 8 and may be implemented as a bus or other interface to facilitate communication among the components of the computing device 220.

The processor 245 may include any processing component configured to receive and execute computer readable code instructions (such as from the data storage component 248 and/or memory component 240). The input/output hardware 246 may include virtual reality headset, graphics display device, keyboard, mouse, printer, camera, microphone, speaker, touch-screen, and/or other device for receiving, sending, and/or presenting data. The network interface hardware 247 may include any wired or wireless networking hardware, such as a modem, LAN port, wireless fidelity (Wi-Fi) card, WiMax card, mobile communications hardware, and/or other hardware for communicating with other networks and/or devices, such as to communicate with the vehicle sensors and the environment sensors (i.e., a transceiver). The network interface hardware 247 may communicate via the Internet to receive vehicle data provided from one or more sources as well as communicate with a display device, such as virtual reality headset to display the virtual vehicle and virtual environment.

Included in the memory component 240 may be the operating logic 241, data receiving logic 232, virtual environment rendering logic 233, and transmission logic 233. The operating logic 241 may include an operating system and/or other software for managing components of the computing device 220. Similarly, the data receiving logic 232 may reside in the memory component 240 and may be configured to receive and store environmental and vehicle data from a plurality of environmental and vehicle sensors. The virtual environment rendering logic 233 also may reside in the memory component 240 and may be configured to render the virtual vehicle and virtual environment for display on display device. The transmission logic 234 includes logic to communicate data to and from a plurality of display devices and a plurality of sensors.

The components illustrated in FIG. 8 are merely exemplary and are not intended to limit the scope of this disclosure. More specifically, while the components in FIG. 8 are illustrated as residing within the computing device 220, this is a nonlimiting example. In some embodiments, one or more of the components may reside external to the computing device 220.

It should now be understood that embodiments of the present disclosure are directed to systems and methods of providing virtual parks in a virtual environment where users can gather, discuss topics of common interest, and experience live events. In one example, users can experience a live-streamed real-world vehicle race in the virtual park. Actual vehicle sensor data and environmental data is used to render a virtual environment that reflects the actual environment of the race so that visitors to the virtual park can witness and participate in the real-world vehicle race virtually. Embodiments also provide the ability for users test drive different vehicles, and to try out off-road trails, as well as view different vendors and discuss various topics in a virtual environment.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of presenting a virtual environment, the method comprising:
receiving vehicle sensor data from one or more vehicles in a physical environment;
rendering the virtual environment that represents the physical environment;
rendering one or more virtual vehicle representations of the one or more vehicles using the vehicle sensor data such that movement of the one or more virtual vehicle representations within the virtual environment corresponds with movement of the one or more vehicles in the physical environment; and
transmitting data for displaying the virtual environment and the one or more virtual vehicle representations to a plurality of display devices.

2. The method of claim 1, wherein the virtual environment is generated based at least in part on the vehicle sensor data.

3. The method of claim 1, wherein the plurality of display devices comprises a plurality of virtual reality goggles.

4. The method of claim 1, wherein the virtual environment comprises a plurality of selectable viewing points.

5. The method of claim 4, wherein one selectable viewing points of the plurality of selectable viewing points is from a cockpit of one vehicle of the one or more vehicles.

6. The method of claim 1, wherein the virtual environment comprises video data, three-dimensional model data, or a combination thereof.

7. The method of claim 1, wherein the physical environment comprises a racetrack.

8. The method of claim 7, wherein the virtual environment comprises a virtual representation of the racetrack and one or more meeting locations surrounding the racetrack.

9. The method of claim 1, wherein the physical environment is an off-road trail.

10. The method of claim 1, wherein the vehicle sensor data is generated by one or more sensors provided on or within the one or more vehicles.

11. The method of claim 1, further comprising rendering a selected virtual vehicle for operation by a user within the virtual environment, wherein the selected virtual vehicle is independent from the one or more vehicles in the physical environment.

12. A system for presenting a virtual environment comprising:
one or more processors;
a transceiver for transmitting and receiving data;
a non-transitory computer-readable medium storing instructions that, when executed by the one or more processors, causes the one or more processors to:
receive, using the transceiver, vehicle sensor data from one or more vehicles in a physical environment;
render the virtual environment that represents the physical environment;
render one or more virtual vehicle representations of the one or more vehicles using the vehicle sensor data such that movement of the one or more virtual vehicle representations within the virtual environment corresponds with movement of the one or more vehicles in the physical environment; and
transmit, using the transceiver, data for displaying the virtual environment and the one or more virtual vehicle representations to a plurality of display devices.

13. The system of claim 12, wherein the virtual environment is generated based at least in part on the vehicle sensor data.

14. The system of claim 12, wherein the virtual environment comprises a plurality of selectable viewing points.

15. The system of claim 12, wherein the virtual environment comprises video data, three-dimensional model data, or a combination thereof.

16. The system of claim 12, wherein the physical environment comprises a racetrack.

17. The system of claim 16, wherein the virtual environment comprises a virtual representation of the racetrack and one or more meeting locations surrounding the racetrack.

18. The system of claim 12, wherein the physical environment is an off-road trail.

19. The system of claim 12, wherein the sensor data is generated by one or more sensors provided on or within the one or more vehicles.

20. The system of claim 12, wherein the instructions further cause the one or more processors to render a selected virtual vehicle for operation by a user within the virtual environment, wherein the selected virtual vehicle is independent from the one or more vehicles in the physical environment.
